(19) United States
(12) Patent Application Publication
(10) Pub. No.: US 2012/0148461 A1
(43) Pub. Date: Jun. 14, 2012

(54) PROCESS FOR MULTI METAL SEPARATION FROM RAW MATERIALS AND SYSTEM FOR USE

(75) Inventors: Aik Rosenberg, B' nei Zion (IL); Boris Tarakanov, Beer-Sheva (IL); Sergey Gusakov, Beer-Sheva (IL); Igal Antonir, Omer (IL); Alexander Rogov, Beer-Sheva (IL); Rami Noach, Omer (IL); Ivgeny Jichor, Dimona (IL)

(73) Assignee: Metal Tech Ltd., Beer Sheva (IL)

(21) Appl. No.: 13/391,713

(22) PCT Filed: Aug. 24, 2010
(86) PCT No.: PCT/IL10/00690

§ 371 Date: Feb. 22, 2012

Related U.S. Application Data
(60) Provisional application No. 61/236,335, filed on Aug. 24, 2009.

(51) Int. Cl. C22B 3/00; C22B 3/04; C01G 49/14; C01G 39/00; C01G 39/02; C22B 5/00; C22B 3/02

(52) U.S. Cl. 423/53; 75/392; 75/710; 75/743; 423/1; 266/168; 423/138; 422/604

(57) ABSTRACT

An improved process for the separation of different metal values from raw materials, and an apparatus for carrying out such processes are disclosed.

### FIELD OF THE INVENTION

The present invention relates to an improved process for the separation of different metal values from raw materials containing thereof.

### BACKGROUND OF THE INVENTION

Metals have been produced for many years from ore and waste using pyrometallurgy and only recently the use of hydrometallurgy became more popular especially with the introduction of new methodologies for the separation of other metals. The process conditions for the separation of metals are very specific and may vary depending on the metal to be separated.

Most raw materials contain several elements in different compositions, minerals and structures. In many cases, the recovery of one metal is on the account of another. The recovery itself may at times be extremely difficult and costly, and thus much of the raw materials is not processed and is simply discarded.

Different metals may be extracted from sulfide-containing concentrates by either pyrometallurgy or by hydrometallurgical technologies comprising sequential stages, such as smelting, roasting, atmospheric leaching, autoclave leaching and bacterial leaching. However, the concentrates are difficult to treat by conventional physical processes, and products isolated therefrom are typically impure. The Level of difficulty within specific treatment may be related to morphology, geometry, mineral form and physical properties (e.g., size hardness) of the raw material (e.g., slag, combined concentrates, ore, tailing etc.).

Metal smelters are sources for global air pollution, and thus of serious environmental concern, causing industrial plants to invest substantially in different environmental abatement systems as well as in the search for new clean technologies for the isolation of metals from such sources.

Roasting of metal sulfide concentrates is generally conducted in air at a temperature ranging from 550 to 900° C. During roasting, the sulfur in the sulfide compounds is converted into gaseous SO₂, which is an undesirable air pollutant. This, together with the production of additional polluting gases (e.g., CO₂ and other greenhouse gases) and undesired dust, increases the need for costly air pollution treatment systems. Furthermore, the concentrates often contain mixtures of metallic compounds, which are all roasted, thereby forming many impurities in the desired metal oxide product.

Melting of concentrates and ores as well as sulfides to produce molten metals is conducted at much higher temperatures reaching as high as 2,000° C., generating also high volumes of dust, gaseous emissions of SOx, NOx, CO₂, CO as well as sublime metal particles.

Hydrometallurgical methods for treating different concentrates including sulfides have been adapted from gold production from as early as the 1940's and include a number of specific processes. For example, for copper compounds common hydrometallurgical processes are the Phelps Dodge process, the CESL-process, the Activox-process, Western Metals process, Dynatec-process, The Nitrogen Species Catalyzed (NSC) process, Intec-process, HydroCopper process, BioCop-process etc.

The NSC process is based on moderate pressure oxidation at a temperature ranging from 125 to 155° C. (above the sulfur melting point), in a sulfuric acid media, with sodium nitrate addition as catalyst. Disadvantages of this process are the need for ultra-fine grinding (80% of particles below 10 microns), and the formation of sulfur pills, which make slurry transportation more difficult in a continuous mode of operation.

Another process for the treatment of metal sulfides involves leaching of the metal-containing minerals with nitric acid in a sealed vessel under increased partial pressures of oxygen and at elevated temperatures [1]. The nitric acid leaching processes result in different products, depending on the specific sulfide, which is reacted with the acid.

The major disadvantage of such processes, which has rendered them uneconomic in the past, is discussed in [2]. The disadvantages are associated mainly with the difficulty of recovering the desired products from the leach liquor. While it is known that such solutions can be treated by solvent extraction and ion exchange techniques to separate the metal values from the acid leach liquor [3], such processes are relatively difficult and costly as they involve complex and expensive solvent extraction of the entire liquid component of the reaction mixture.

Alternative leaching processes, such as that described in [4] suffer from many disadvantages, some of which are related to the fact that a large initial concentration of nitric acid is required as well as the need to use pure oxygen (costly and dangerous), the need of large volumes of washing water (and recovery thereof), and complications associated with the need to lower the nitric acid concentration prior to metal recovery from the solution.

Thus, there is a long and felt need to find an improved process to efficiently isolate metals, either as oxides or as salts, from minerals containing metal sulfides, which are efficient, environmentally safe and versatile to be used for the production of different metals from the concentrates.

A smelter slag is an associated byproduct of the smelting processes. The slags are complex materials comprising among others sulfides, oxides, metal oxides silicates, glassy conglomerates of amorphous materials and even some free metals where the chemical valence of the metal elements varies and creates difficulties in adapting separation technologies thereafter. In general, the slag material has been, due to its complex nature, considered a waste product from which the metal values have been recoverable only by expensive and complex processes. Although certain commercial uses for slags do exist, such as road fillers, the full value of the individual components contained therein is generally unrealized due to the unavailability of effective economical processes for separation of individual ingredients from the complex slag matrix.

Currently available technologies for recovering specific materials, particularly specific metals from smelter slags are based among other on re-smelting or crushing, grinding, and milling the slag to fine particles and subsequently separating and recovering a certain portion of the single element by flotation techniques. The leftover which usually makes up mo less than 99% of the feed is dumped as slurry in “tailing ponds” which are considered an environmental hazard due to the fine dust which is swept by the wind and also due to the considerable water contamination by high acid levels.

Other processes for slag treatment involve crushing and leaching the slag with acids in order to recover a single element. As acid leaching lacks selectivity and thus dissolves a vast portion of iron and other slag constituents, such acid-based processes have not been effective and economical

U.S. Pat. No. 4,261,738 to Valentine et al. [5] discloses a process for recovering precious metals from a bimetallic material in which the precious metal is mechanically bonded to a base material. The process is particularly suited for recovering karat from filled gold scrap.

U.S. Pat. No. 4,322,390 to Tolley et al. [6] discloses inter alia a hydrometallurgical recovery of copper, cobalt and nickel. The desired metal values are recovered from metal-bearing sources by subjecting the metal-bearing sources to a reduction step, followed by oxidative and chelating steps.

Fathi Habashi discloses the treatment of Titanium slag by concentrate sulfuric acid; the process involves separation difficulties [7].

### REFERENCES

[1] Bjorling and Kolta, Intern. Mineral Process. Congr., Tech. Papers, 7th, New York City, 1964, pages 127-38 and in J. Chem. U.A.R. 12, No. 3, 423-435, 1969.

[2] CA 905,641

[3] U.S. Pat. No. 3,739,057

[4] U.S. Pat. No. 3,988,418

[5] U.S. Pat. No. 4,261,738

[6] U.S. Pat. No. 4,322,390

[7] Textbook of Hydrometallurgy by Fathi Habashi, laval university, Quebec City, Canada, 1999, pages 276-280.

### SUMMARY OF THE INVENTION

It is the purpose of the present invention to provide hydrometallurgy processes for recovering metal values (elements) from raw materials, e.g., slag, concentrates, ore, tailings, solid waste streams etc, and production therefrom of different salts and metals in different purity levels, as required. The processes of the invention are substantially devoid of the disadvantages associated with existing processes, as will be further demonstrated herein.

The process of the invention is directed at the conversion of metals (e.g., sulfide metals, reduced forms of metallic elements), comprised within the raw material or mineral source, into the corresponding oxides, and generally to enable the recovery of elements for use or further purification. The process of the invention permits the isolation of a large variety of metal values and other non-metallic elements. The process of the invention, in contradiction to processes of the art, employs relatively low temperatures and small amounts (e.g., catalytic amounts) of active materials, such as acids (e.g., nitric acid) or other oxidants (e.g., chlorate ions, hypobromite ions, hypochlorite ions) which are recycled, reused and/or refreshed by make-up in situ, as further disclosed hereinbelow, without imposing environmental and economic hardship. The process of the invention utilizes reactive agents for oxidation (e.g., nitric acid, chlorine oxides, bromates, chlorates etc) along with means for separating the converted constituents from the reaction mixture (for example by in-situ flotation affect, etc.) in high purity.

Thus, in a first aspect of the invention there is provided a process .e.g, a hydrometallurgical process, for isolating at least one metal value from raw material, said process comprising disintegrating said raw material under conditions selected to enable isolation of said at least one metal value in a form selected from oxide, salt, complex and free metal.

The process for isolating the at least one metal value from the raw material comprises:

(i) contacting said raw material in a vessel in the presence of a medium, wherein said medium comprising at least one oxidant, the vessel is configured to define a predetermined temperature and/or pressure condition causing separation of a gaseous phase from said medium in contact with the raw material and providing a desired time of interaction between the separated gaseous phase and the raw material;

(ii) allowing said material to flow within the vessel to permit disintegration of said raw material and free said at least one metal value from the raw material, to enable isolation of said at least one metal value in a form selected from oxide, salt, complex and free metal.

In another of its aspects, the invention provides a reactor, e.g., for carrying out a process of the invention, as a continuous process or as a batch-wise process. The reactor comprises at least two interconnected reaction chambers (sections), each two locally adjacent reaction chambers being connected to one another, each chamber having a partition in the form of a material passage unit being an outlet opening for one chamber and the inlet opening for an adjacent chamber, said material passage unit being configured to define within a chamber a predetermined pressure condition causing separation of a gaseous phase from said material and providing a desired time of interaction between the separated gaseous phase and remaining material, after which the material flows through the outlet of said chamber into the adjacent chamber and towards the passage unit defining a partition between said adjacent chamber and a subsequent chamber, the time of interaction between said gas phase and the material in each of said at least two chambers defining the reactor throughput.

### DETAILED DESCRIPTION OF THE INVENTION

The process of the invention may be used for isolating metal values from raw materials of various origins and compositions. The raw material may be any solid waste, such as a smelter slag, a combined concentrate, an ore, a solid waste stream, a tailing, or any combination of the aforesaid.

The “smelter slag”, or “slag”, as being a raw material processed in accordance with the present invention may be any slag material, such as a copper slag, a nickel slag, an iron slag and other metal slags obtained from smelting of raw materials including ore, concentrate etc. The material which is processed according to the invention may be a slag of a known composition or slags of several origins having variable metal compositions depending e.g., on the type and origin of the original smelted ore, the particular smelting process, and other concentration-dependant factors having to do with, e.g., prolonged weathering effects.

The slag is also an associated byproduct obtained from smelting of raw material in the mining industry. In some embodiments, the smelter slag is a copper slag. In other embodiments, the smelter slag is a nickel slag. In further embodiments, the smelter slag is an iron slag or other residue generated at pyrotechnology plants.

The “combined concentrates”, or “concentrates” refer to concentrates of metal value as combined materials, obtainable, for example, as a byproduct stream in the industrial mining processing, such as tailing containing poor or enriched content of metal values. The concentrates may be of solid materials, semi-solid materials, liquid materials or a suspension of solid material(s).

As known in the art, an “ore” is a rock comprising minerals with various elements including metals. The “tailings” is the material remaining after the extraction of an ore from its host material.

Non-limiting specific examples of such raw materials include fayalite (Fe₂SiO₄) such as that in copper slags, sphalerite (zinc sulfide blends), copper minerals such as sulfides as bornite (Cu₅FeS₄), chalcocite (Cu₂S), covellite (CuS), and digenite (Cu₉S₅); carbonates such as malachite and azurite; and oxides such as cuprite (Cu₂O).

The metal value to be isolated from the raw material may be present in the raw material in any form, such as a metallic or elemental form, an oxidized form, a reduced form, a sulfurized form or in combination of any two or more forms, e.g., a specific metal may be present in the raw material as a mixture of a metal oxide and a metal salt. The form of the metal value may be its natural form in the ore, i.e., as found in nature, or its processed form, i.e., as found in the processed slag material. Notwithstanding its original form in the raw material, the metal value may be isolated in a form different from its original form, said isolated form may be the result of any one process step affecting, e.g., its oxidation state, composition, etc. The metals may be isolated as oxides, as sulfide metals, as metal hydroxides or as metallic ions (metal salts).

Raw materials typically comprise a great variety of elements of commercial interest. These elements, referred to as “metal values” are, in most general terms, elements of the periodic table. In the context of the present invention, the metal values include such elements which are traditionally known as metals, as well as other non-metallic elements. The process of the invention is directed at separating one or more of elements such as Cu, Fe, Si, Ca, Al, S, Zn, Pb, Au, Ag, U, Ni, Co, Re, V, W, Sn, Se, Te and Mo.

Prior to the contacting of the raw material with the oxidant under the conditions of the process, the raw material may initially be treated for size diminution by one or more of grinding, crushing, milling, attrition, dissolution or any other physical or chemical processing, so that large slags are broken down into smaller fragments that may be treated more effectively. In some embodiments, the raw material is, e.g., crushed down to particles a few millimeters in (averaged) diameter, in some embodiments 2-100 mm. In other embodiments, the raw material is, e.g., crushed down to particles a few microns or tens of microns in (averaged) diameter, in some embodiments 2-100 microns. As exemplified, the material particles may subsequently be classified (i.e., separated according to size) and further crushed or milled based on their size. The size diminution process may be carried out dry or in the presence of water, or in the presence of an aqueous solution or an acidic solution, which may simultaneously chemically disintegrate and leach out one or more of the metal values.

Upon contacting the raw material with a medium, e.g., liquid medium, a heterogeneous slurry solution results, the solution comprising a soluble material, an insoluble mass in the form of fines or other powder-like material, and an insoluble material of a larger particle size. The slurry is subsequently treated with at least one oxidant, i.e., an oxidizing agent, which may be introduced thereto following contact with the medium or may alternatively already be present in the medium, and the raw material is permitted to disintegrate and the metallic components to leach out into the medium.

Typically, the oxidant is an acid, which may be introduced into the medium or slurry, as such, or which may be generated in the medium/slurry from a pre-form subsequent to its addition. The acid may be selected from elementary halogens (e.g., chlorine and bromine), halogen oxides, halogenic oxy-acids and other oxidants capable of rendering water acidic, i.e., acids such as nitric acid, sulfuric acid, hydrogen bromide, hydrogen chloride and any mixture of the aforementioned acids.

In the process of the invention, the oxidant concentration is at most 50 grams per liter (g/l). In some embodiments, the oxidant concentration is between 10 and 30 g/l, or between 20 and 50 g/l or between 15 and 25 g/l.

The medium containing the oxidant, e.g., acid may be an aqueous medium or a gaseous medium.

In a non-limiting example, the oxidant is nitric acid or a medium comprising thereof, such as an aqueous nitric acid solution, said medium comprising, in some embodiments, nitric acid and oxygen in a mixture with nitrogen as a carrier (inert) gas. In such embodiments, the nitric acid concentration is at least 10 g/l and is typically at most 60 g/l. In some embodiments, the nitric acid concentration is at most 30 g/l. In further embodiments, the nitric acid concentration is between 10 and 60 g/l or between 10 and 30 g/l, or between 15 and 25 g/l or between 20 and 25 g/l.

In alternative embodiments, the oxidant is hypobromite (e.g., sodium hypobromite) in combination with bromine, e.g., in a mixture with nitrogen as a carrier gas. In some embodiments, the bromine concentration in the gas flow is between 20 and 60% or between 20 and 40%. In other embodiments, the bromine concentration in the gas flow is 40% or 50% or 60%. In yet further embodiments, the bromine concentration in the gas flow is at most 40% or at most 50%.

The hypobromite ion concentration is at least 20 g/l or at least 30 g/l. In other embodiments, the hypobromite ion concentration is at most 60 g/l or at most 70 g/l. In further embodiments, the hypobromite ion concentration is between 20 and 70 g/l or between 30 and 60 g/l. In some embodiments, the hypobromite ion concentration is 50 g/l.

When hypobromite is used as the oxidant, a base such as NaOH may be introduced to the slurry to stabilize the hypobromite solution. In such embodiments, 20% NaOH may be used. Typically, a ratio of 1.4-2.2 mole NaOH to every 1 mole of bromine is maintained, such that the pH of the reaction mixture is between about 8.5 to about 9.5, or is about 8.5 or about 9.0 or about 9.5.

Yet still, the oxidant may be a chlorate salt, e.g., sodium chlorate, in combination with chlorine dioxide, in a mixture with nitrogen as a carrier (inert) gas. Where chlorate is employed, the chlorate ion concentration is typically at least 20 g/l, and not exceeding 50 g/l. In some embodiments, the chlorate ion concentration is between 15 and 20 g/l or between 20 and 50 g/l. The chlorine dioxide concentration in the gas flow is at most 70%. In some embodiments, the chlorine dioxide concentration in the gas flow is 50% or is between 40 and 60%.

In other embodiments, the oxidant is a hypochlorite salt in combination with chlorine gas, in a mixture with, e.g., nitrogen as a carrier gas.

The medium (slurry and gaseous) contained in the vessel may also be treated with oxygen or a gaseous mixture comprising oxygen. Gas flow in the system is in fact necessitated by constrains dictated by chemical reaction requirements, heat transfer considerations and hydrodynamics phenomena occurring within the vessel (apparatus) during use. Therefore, the gas may be employed neat or in a mixture with a non-reactive gas (e.g., a carrier gas such as nitrogen). Typically, the oxygen constitutes between about 30 and 100% of the gaseous medium. In some embodiments, the oxygen concentration is between 30 and 90% or between 30 and 50%, or between 50 and 90% of the gaseous medium. In other embodiments, the oxygen constitutes about 50% of the gaseous medium.

The process may be carried out in a continuous mode or as a sequenced batch-wise process, permitting in any of the modes use of lower concentrations (amounts) of the oxidant, e.g., acid, without substantially affecting the conversion. In fact, under the conditions employed, the conversion increases. Specifically, in the process, the raw material is allowed to come into contact with an amount of the oxidant, e.g., acid, and the conversion of the material is permitted to take place, resulting in the initial degradation (consumption) of the oxidant (acid) and its later regeneration by e.g., recycling and/or refreshing by make up in situ. Once generated, it is brought into contact with another portion of the raw material and the leaching resumes. The process of the invention may therefore be carried out in a vessel which allows such continuous conversion of the raw material and regeneration of the oxidant, e.g., acid. Such a vessel may for example be an autoclave (pressure reactor), a continuous autoclave, a vertical or horizontal pipe autoclave structure, and any other as known in the art.

When conducted in a continuous autoclave, with some vertical portions and under a certain flow of gas, due to the flotation properties of the raw material slurry, the material may be captured by gas bubbles which form, and become agitated through the slurry layer. The material thereafter is lifted out to the upper portion of the continuous autoclave, and remains covered with a blanket of the oxidizing gas. At this portion of the autoclave, a more concentrated material (now in a foam structure having a large surface area) is formed, which due to the presence of the gas blanket and the inability of the raw material slurry/foam of three phases (gas, liquid, solid) to move forward, the residence time of the unreacted elements at this reactive zone increases (time of interaction), causing an increase in product conversion. Upon conversion, the oxide which is formed separates and the process similarly continues, while some of the metal becomes dissolved in the solution.

Typically, the process may be carried out under atmospheric pressure, however, higher pressures may be used in order to increase or make more efficient the isolation of metal values from the raw material. Under normal operating temperatures, the temperature in the vessel is kept above 90° C., above 100° C., above 110° C., above 120° C., or above 130° C. In some embodiments, the temperature is in the range of 90-130° C., or 100° C.-160° C. or 130° C.-160° C.

The process of the invention, carried out in accordance with the conditions disclosed herein, thus comprises:

(i) contacting said raw material in a vessel with an acidic medium, under predetermined temperature and/or pressure conditions causing separation of a gaseous phase from said medium in contact with the raw material to convert at least an amount (e.g., at least 1%) of the metal values contained in said raw material into a corresponding medium-soluble form (e.g., salts);

(ii) allowing said raw material to continuously flow within the vessel to permit disintegration of a further amount of the raw material, until the metal values (substantially all metal values, at least 70%, 80%, 90%, 95%, or 100%) are leached out from the raw material into the medium to obtain a leach liquor;

(iii) separating vapors and gases from the medium (i.e., comprising the leach liquor and insoluble solid material) for acid condensation and recirculation;

(iv) separating the leach liquor, e.g., by means of a liquid-solid separation, from the insoluble material; and

(v) separating the insoluble material as a solid cake, optionally drying and further optionally calcining the cake to obtain metal oxides of a desired grade, e.g., which may be further treated for higher purification, removal of contaminants, etc.

Optionally further, the process may involve dissolving the cake and separating therefrom the metal values by, e.g., ion exchange and/or solvent extraction systems and selective separation of the different elements by, e.g., differential flotation and the surface tension characteristics, or by any other method known in the art.

In some embodiments, the process further comprises oxidization of the leached metal values in the acidic medium, under conditions of temperature and/or pressure and in the presence of air/oxygen and/or other oxidants; and allowing the slurry to float by the introduction of a gas flow into the vessel, e.g., the gas flow may be introduced in various directions, through a variety of nozzles positioned in relationship to the slurry flow.

In further embodiments, the process further comprises separation of the medium-soluble ions using, e.g., ion exchange and/or solvent extraction systems and selective separation of the different elements by, e.g., differential flotation and the surface tension characteristics.

In other embodiments, the elements are oxidized in a continuous fashion under pressure in the presence of a base material, such as sodium hydroxide or sodium carbonate, in an aqueous solution, and further in the presence of oxygen/air. The reaction time is decreased substantially with increasing pressure and temperature. The sodium ions in the solution may be further processed and purified in ion exchange or solvent extraction systems.

In other embodiments, the oxidized elements isolated from the raw material or which are contained in the leach liquor, are reduced to the corresponding metal form by a reducing agent, such as carbon or a gas e.g., carbon monoxide Syngas, hydrogen gas, which is introduced into the reactor. The reduction process may be carried out under pressure.

In some embodiments, the metal value is selected from copper, iron, nickel, molybdenum, gold, silver, zinc, arsenic, and rhenium. In further embodiments, the process permits the separation of elemental sulfur or oxidized sulfur such as sulfuric acid. In some embodiments, the process enables the production of high quality oxides and salts from an initially separated low grade materials.

The invention, in another of its aspects, provides a reactor for carrying out the process of the invention, as a continuous process or as a batch-wise process. In some embodiments, the reactor is adapted for continuous leaching of slurry of a raw material in an acid medium, under conditions of temperature and pressure permitting the conversion of at least an amount of at least one metal contained in said raw material into the corresponding metal oxide and/or salt.

In some embodiments, the reactor comprises means for acid condensation and recirculation. In additional embodiments, the reactor comprises means for separating the leach liquor from the solution.

In some embodiments, the reactor is a vertical column reactor (a pipe autoclave).

In further embodiments, the reactor comprises at least two interconnected reaction chambers (sections), each two locally adjacent reaction chambers being connected to one another, each chamber having a partition in the form of a material passage unit being an outlet opening for one chamber and the inlet opening for an adjacent chamber, said material passage unit being configured to define within a chamber a predetermined pressure condition causing separation of a gaseous phase from said material and providing a desired time of interaction between the separated gaseous phase and remaining material, after which the material flows through the outlet of said chamber into the adjacent chamber and towards the passage unit defining a partition between said adjacent chamber and a subsequent chamber, the time of interaction between said gas phase and the material in each of said at least two chambers defining the reactor throughput. In some embodiments, said material passage unit is in the form of a perforation pattern.

As a person versed in the art would appreciate, the reactor of the invention may be constructed as a single operating reactor system or as an array of reactors, each reactor unit in the array system being connected directly or indirectly to another of the reactors in the array.

Generally, as used herein, the reactor system comprise a reactor, i.e., a vessel or apparatus in which the process is carried out and in addition may further comprise a temperature control unit, such as a heating/cooling unit or a heat exchanger, along with means for controlling said unit in response to autothermic or the absence of autothermic conditions within the reaction chamber; internal temperature gauges for monitoring the reaction's temperature; condensation units, scrubbing units and absorption columns, to afford treatment of gaseous reaction products and gaseous contaminants; baffles of various geometries for controlling the flow profile of a material within the reactor; a gas-bubbling unit to allow for the supply of gas into the reaction zone; a top plate that is movable with respect to an outer body of the reactor; a base plate that is movable with respect to an outer body of the reactor; reactants inlets at various angles; and products outlets at various angles.

A reactor according to the present invention is schematically demonstrated in FIG. 1. The reactor 1 schematically illustrated is a non-limiting example of a reactor comprising 6 reactions chambers (sections). The chambers, sections 10, 20, 30, 40, 50 and 60 are linked to each other such that the outlet mixture of section 10 is the inlet mixture of section 20, the outlet mixture of section 20 is the inlet mixture of section 30, etc, with each chamber (section) having a partition in the form of a material passage unit which may be an elongated portion such as a hollow tubing structure 70, 80 (as demonstrated for sections 20 and 30) or a partition separating two sections 90, 100, 110 (as demonstrated for sections 10 and 20). For each section 10, 20, 30, 40, 50 and 60, the ratio between section length and section diameter is from 4 to 12. However, these ratios may be varied depending on the size of the reactor (autoclave) and on hydrodynamics, to guarantee an even flow of slurry through the autoclave, on one hand, while avoiding an excessive autoclave height, on the other hand

It should be understood that the illustration given in FIG. 1, whereby each two chambers (sections) are connected to two other chambers by way of a hollow tubing structure for solid, liquid or gas communication, is merely a single construction of a reactor according to the invention. In a different construction of a reactor according to the invention, all 6 chambers may be connected to each other, as a vertical column, having a partition in the form of a material passage unit separating between each of the sections 10, 20, 30, 40, 50 and 60. In FIG. 2 one section S1 of such a construction is illustrated in detail.

As demonstrated in FIG. 2, each section has two partitions S2 and S3 separating this section from the neighboring sections, such that a crossover tube, S4 and S5, is positioned in the middle of each partition S2 and S3. The partition S2 and S3 is provided with perforations S6, e.g., multiple holes for gas outlet from one section to another (from lower sections to higher sections). The holes in each partition range from 0.5 to 2% of the cross-section surface of the reactor. The holes are designed to permit proper size of gas bubbles to form for high mass transfer rates at a velocity necessary for hydrodynamics within the operation of the reactor. Using holes occupying less than 0.5% of the pipe cross-section area resulted in a large volume of a slurry-free area, leading to a decrease in the slurry volume and a subsequent decrease in the retention time.

The design of the cross-section enables achieving a high speed of gas flow therethrough. Without wishing to be bound thereto, since the hydraulic resistance is increased in the partition part, a gas blanket (slurry-free area) S7 is formed below the partition S2. The crossover tube S4 is placed such that one end of the tube is hermetically connected with partition S2 and the other is placed lower than the low level of gas blanket S7, into the slurry S8. This serves for the slurry cross-flow from a lower section to the next higher one.

In some embodiments, the reactor capability, in terms of solids feed flux, is typically in the range of 100-300 [kg solids/Hr/m²]; in other embodiments, the range is of 80-210 [kg solids/Hr/m²] or 60-125 [kg solids/Hr/m²].

In some embodiments, the oxidant gas is introduced into the continuous autoclave from the lower side in the form of bubbles, thereby elevating the solid particles in the slurry to affect a three-phase system, e.g., which under pressure and temperature accelerate the reaction. In such embodiments, the gaseous oxidant is optionally introduced from the lower side into the slurry, causing the flotation of the different elements, e.g., as sulfide metals and by this virtue separation of sulfide elements and sulfur from the oxidized elements.

In other embodiments, the gaseous flow is introduced in a peripheral way into the continuous autoclave, preferable a circular type, to thereby introduce a circulating flow that would increase the yield of the reaction while reducing erosion of the autoclave.

The water or an aqueous solution may be introduced into the circular autoclave in the peripheral tangential way. In other embodiments, water or an aqueous solution is introduced into a circular rotating reactor or rotating feeding system where, as the solid raw material is reacted e.g., oxidized, sulfatized, sulfurized in an exothermal or endothermic way, all metals are dissolved in a continuous fashion.

The process of the invention is clearly advantageous over processes known in the art and the following conclusions may be drawn:

The three-phase continuous process of the present invention provides a higher process rate with respect to other processes known in the art, due to the lowering of mass transfer barriers in comparison to simple solid-liquid contacts as known in the art. High mass transfer rates are achievable where in-situ heat transfer is achieved due to humidification of gas bubbles at saturation conditions in the thermodynamical equilibrium which is a part of the structure of the reactor, e.g., continuous reactor, of the invention.

The simple construction of a continuous autoclave with the absence of moving parts decreases capital, working costs and corrosion defense.

In the process of the art, the slurry from the autoclave is saturated with gas, which makes filtration more complicated; in the process of the invention, such is not the case.

The continuous mode of the process of the invention is easily maintained, as parameters (temperature and pressure) are changed in a narrow range. In the processes of the art, the influence of such parameters complicates the processes. As may be known, such complications and possible loss of control, particularly of reaction rate (NO formation and oxidation) may lead to the sudden increase of pressure and temperature. This requires usage of autoclaves of higher pressures and, as a result, resulting in higher equipment costs.

The regeneration of the oxidant in the process of the invention removes the need to attend to acid volatilization before recovering the values.

The simultaneous treatment of different elements having low concentrations can be beneficial in several cases, such as the filtration, and precipitation of silica, adsorption of arsenic, molybdenum, and rhenium.

The possibility of introducing electric charge on line in flow in order to change ion affinity of the different elements for better selectivity, better precipitation, and filtration.

As used herein, the term “about” refers to ±20% of the indicated value.

In another of its aspects, the invention provides an improved hydrometallurgical process which is more selective and more efficient at recovering metal values present at various concentrations and forms in waste smelter slag material. In this respect, the process of the invention involves the disintegration of a smelter slag, such as a copper slag, a nickel slag, an iron slag and other metal slag either by mechanical (e.g., crushing, milling, attrition) and/or by chemical means and treating substantially all its components as a group or individually, while leaving substantially no residues (tails). This permits avoiding the use of a non-selective high temperature pyrometallurgical processes while permitting chemical disintegration at moderate temperatures by using oxidative chemicals and reactants in an aqueous medium.

The processes of this aspect of the invention not only provide a long sought response to the inability to separate minute amounts of metal values such as copper, zinc, molybdenum, silver and gold from such slags, but also provide separation of large amounts of iron and silica, thereby reducing the environmental burden from their disposal.

Where the disintegration is carried out in water, after the size reduction has afforded slurry of a particulate matter of a desired size, an aqueous salt solution or acidic solution is added. The slurry is subsequently leached, either under ambient conditions or under elevated temperatures and/or pressure, e.g., in the presence of an aqueous solution, being selected from ammonium salts such as ammonium sulfate, ammonium carbonate or bicarbonate, ammonium halide such as chloride and fluoride and others. In some embodiments, the ammonium salt solution is ammonium bifluoride. In some embodiments, the aqueous solution is a mixture of two or more salts. In other embodiments, said aqueous solution is ammonium bicarbonate or a salt mixture comprising thereof.

In some embodiments, the leaching media is or contains an oxidant, typically an aqueous acidic oxidant such as sulfuric acid.

Pressure-leaching of the slurry may involve, depending on the pressures required, the use of an autoclave to improve solubility of the slurry and shorten the time for leaching one or more of the materials, e.g., values, contained within the solid. Once leaching is completed, the solution is separated from the insoluble residue. The pressure-leaching may occasionally utilize an oxidant such as oxygen in order to adjust the content valancy and eliminate the presence of unwanted compounds. In an non-limiting process, the pressure-leaching step is carried out under a pressure ranging from 3 to 15 bars, depending on the oxygen concentration, an oxygen concentration in the range of 20% to 100% (of the total vapor volume) and at a temperature of between about 50° C. to 100° C. The retention time is typically within the range of 0.5-1.5 hour. Non-pressurized leaching is typically performed while milling at ambient pressure, under an oxygen concentration being in the range of 20% to 50% and at a temperature between about 50° C. to 60° C. Under such conditions, the retention time is typically within the range of 1 to 5 hours.

As a person skilled in the art would appreciate, the leaching step may be carried out either in an autoclave, in case elevated aqueous medium temperatures are required, or in a standard reactor in case of low positive pressures. In some embodiments, a process may utilize either pressure-leaching or non-pressurized leaching. In other embodiments, the slag particles treated as disclosed herein may undergo initial non-pressurized leaching followed by pressure-leaching.

The slurry which results may be separated by filtration to a filtrate and a filter cake, with each being treated separately. In some embodiments, the filtrate is subjected to metal ion-exchange (anions and/or cations) which may be followed by electrowinning to obtain a metal value. For example, the filtrate is subjected to ion-exchange which may be followed by electrowinning to obtain the desired metal.

The filter cake having been separated from the filtrate, as disclosed above, may at this stage of separation be directed to a treatment chamber and attacked by ammonium bifluoride or an equivalent thereof, e.g., ammonium fluoride, under conditions permitting conversion of silicate contained in said solid cake to ammonium hexafluorosilicate which separates from the solid mass comprising iron salts. Once the volatile ammonium hexafluorosilicate or silicon tetrafluoride separates, the mass containing iron may be allowed to undergo reduction to produce metallic iron. The resulting ammonium hexafluorosilicate by product is treated with a basic medium, e.g., containing ammonium, allowing its conversion to silica.

While the fluorination step is directed at the separation of silica from the retentate, other components comprised therein, such as iron, calcium, aluminum and others may undergo fluorination. The fluoride may be recovered and reused.

Alternatively, as stated above, the disintegration of the slag is carried out in an aqueous salt solution, e.g., ammonium carbonate solution. This disintegration provides concurrent reduction in particle size and leaching of copper, e.g., in a soluble form or partially soluble.

In other embodiments of the invention, in the process of the invention, the disintegrated smelter slag is treated with ammonium bifluoride or with at least one equivalent thereof under conditions which permit to first separate silica from the slag. In such embodiments, the disintegrated slag is treated so as to convert silica contained therein to ammonium hexafluorosilicate or silicon tetrafluoride, as described above and further below, which may then be separated from the non-volatile residues, to precipitate silica.

The non-volatile residues from which silica was separated are next calcined with steam, e.g., at a temperature between 350-450° C. to convert iron fluoride to iron oxide. In some embodiments, the resulting oxides are then treated by pressure-leaching with e.g. aqueous ammonium carbonate and the leachate is filtered leaving behind a de-copperized solid mass which upon reduction affords metallic iron. This mass may be separated prior to reduction into magnetic and non-magnetic materials. In some embodiments, only the magnetic material is reduced.

The filtrate may be subjected to copper and molybdenum ion-exchange, followed by electrowinning of copper. Molybdenum, in turn, can be eluted as sodium or ammonium molybdate or subsequently calcined to molybdenum oxide.

The copper metal may be isolated as a final product or as an intermediate in a salt form, such as a sulfate.

Iron and silica may be separated from the disintegrated slag following treatment with a solution of ammonium bifluoride. Once the ammonium hexafluorosilicate is evaporated, it is collected and filtered. The filtrate is treated, e.g., by ammonization, to allow co-precipitation of iron, e.g., in the form of iron oxide, and silica. Separation of the iron oxide from the silica may be carried out for example by volatilization of the silicon due to residual amounts of ammonium bifluoride left in the cake after filtration. The remaining iron oxide may at this stage be reduced to the corresponding metallic iron.

The present invention also provides in a further aspect an alternative to the metallurgical processes disclosed above. Accordingly, the disintegrated smelter slag is treated with ammonium bifluoride or with at least one equivalent thereof, as disclosed above, to obtain heterogeneous slurry which is filtered to provide a filtrate and a solid cake. The filtrate is first ammoniated to allow co-precipitation of iron, e.g., in the form of iron oxide and silica, as above. Upon volatilization of the silicate, the iron oxide is separated and reduced to metallic iron.

The solid cake is treated with aqueous or dry ammonium salt and then the clear leachate is subjected to copper ion-exchange, and in some embodiments, electrowinning to thereby obtain metallic copper. Separation of further residual iron from said cake, optionally following magnetic separation, may proceed at this stage as disclosed above.

In some embodiments of a process according to the invention the crushed raw slag is reacted with ammonium bifluoride, or an equivalent thereof, to convert the silica into soluble ammonium hexafluorosilicate that is leached and filtered off; the residue, which comprises of virtually silica-free disintegrated slag particles is subjected to Cu/Mo leaching with aqueous ammonium salt (e.g., sulfate, carbonate, fluoride etc.); the fluorosilicate-loaded filtrate is ammoniated to co-precipitate iron and silica and the precipitate filtered off; the filter cake is then mixed with a small additional portion of ammonium bifluoride and the mixture is heated up to 350° C. to convert the silica and sublime ammonium fluorosilicate, which is subsequently hydrolyzed to yield high purity precipitated silica; as will be described further hereinbelow, the above process steps may be carried out in a multiple-zone reactor according to the invention, said reactor being vertical or horizontal, with the reactions being carried out sequentially. The post-sublimation residue consists of high purity iron oxide powder that can be further reduced to iron metal; the Cu/Mo leachate is subsequently subjected to selective ion-exchange processing, while the associated leach-residue solids, which constitute an additional iron oxide product, may be further split into magnetic and non-magnetic portions.

In other embodiments, the slag is mixed with ammonium bifluoride and heated gradually to 350-400° C. to separate the silica after its conversion (at 200-250° C.) as ammonium fluorosilicate by sublimation; the residue is than hydrolyzed by steam to recover the ammonium fluoride (by scrubbing from the vapor phase) while converting the metals to their oxides; this process can be carried out either in separate vessels or in a combined reactor according to the invention; heat evolution during this process acts as an energy source for the reaction, thereby improving energy efficiency.

In still other embodiments, the silica can be leached first, in a liquid phase at ambient or somewhat elevated moderate temperature (25-95° C.) whilst the fluorides of silica, iron, aluminum, calcium etc., are dissolved; the insoluble residue is filtered off, consisting of a part of the iron and copper for further recovery of the values; the filtrate is pH controlled to higher pH by ammonium hydroxide in order to precipitate iron and silica either together or sequentially (by controlling the pH in the range of 9-12); in the case of co-precipitation, a further separation step may be employed in order to recover the individual constituents by reacting the residue with ammonium bifluoride, as disclosed above.

Further, in a process of the invention, the pre-milled slag is first reacted with ammonium carbonate in a controlled high pH (by ammonia) environment to extract the copper away (at e.g., 50° C.) followed by higher operating temperatures (e.g., 95° C.); Under such sequential process where the milling/attrition and leaching are combined into one step (leaching during milling), the solids are filtered off and washed from the solution consisting mainly of iron and silica and some minor metals such as aluminum, sodium and potassium and others as disclosed herein; these solids are further treated to separate and recover the valuable metals by either of the above processes.

In other embodiments, the leaching of the whole slag is conducted by acids by atmospheric or heap leaching. As the solution contains all or most of the elements to be further separated, electro-winning, crystallization, ion exchange and/or solvent extraction and precipitation methods are used to separate each value. The insoluble matter undergoes further leaching in a different acid or base solution to be further undertaken by ion exchange/solvent extraction precipitation.

Thus, the invention also provides, in another of its aspects, an alternative process for recovering metal values present at various concentrations and forms from waste smelter slag material. In this process, the slag material is contacted with an acid solution (of any acid, e.g., sulfuric acid) under condition permitting dissolution of the slag and formation of slurry, which is subsequently subjected to leaching. Leaching of the slurry may involve the use of an autoclave to improve the solubility of the slurry and shorten the treatment time of leaching one or more of the materials, e.g., values, contained within the slag.

In some embodiments, the leaching is atmospheric leaching. i.e., non-pressurized carried out at ambient pressure, under an oxygen concentration being in the range of 20% to 50% and at a temperature between about 50° C. to 60° C. In some embodiments, the resulting leachate is separated into a solid cake and a filtrate, with each being treated separately.

In some embodiments, the filtrate is subjected to filtration by any one method of depth filtration, e.g., through sand bed, or by the use of flocculants (e.g., chemical flocculation and/or electro flocculation) together with other filtration mechanism, of different mesh size, or any known process for silica removal.

In some embodiments, electricity is applied to the solution to alter the electric characteristic of the different ions and molecules contained therein, to thereby alter the hydroscopic behavior of the silica, resulting in better filtration and precipitating.

In some embodiments, the filtrate thereafter is subjected to crystallization. The crystallized solids are subjected to oxidation and subsequent roasting. The resulting sulfur oxides such as trioxide is directed into a typical scrubber so it may be converted to sulfuric acid, to be further recycled. The ferric oxide which collects undergoes reduction to iron powder.

In some embodiments, the sulphates are oxidized in a roaster, such as fluidized bed, rotating and multi hearth. The different oxides are further being separated and purified by known hydrometallurgy technologies such as leaching, precipitation and solvent extraction and/or ion exchange.

The solid silica mass collected after filtration is subjected to repulping and filtration to separate the silica containing solid or liquid mass from other metal values. The silica containing mass is treated with a base, e.g., caustic, the solid cake is separated and the leachate is further treated to isolate the silica.

The silica-free solid mass is combined with the solid cake obtained following treatment of the slug material with acid and subjected to sulfating by the reaction of aqueous solution with sulfuric acid or sulfur at a temperature 90-180° C. in a continuous rotating apparatus means followed by repulping and filtration. The filtrate is subjected to molybdenum ion-exchange (IX) to obtain molybdenum product and the molybdenum-free solution is further subjected to copper solvent-extraction (SX) to obtain metal copper.

In other embodiments, the oxide metal is reduced by gaseous e.g., hydrogen gas, Syngas, carbon monoxide, carbon-based or by other reduction process to produce metal powders or directly a metal smelt.

The invention further provides in another of its aspects a multi-zone reactor assembly for silica conversion, said assembly comprising a reactor having at least three continuous zones comprising: (a) a conversion zone located in the reactor's one end for providing a slurry of smelter slag particulates and ammonium bifluoride; (b) an hydrolysis zone located in the reactor's other end for providing water to decompose the fluorides; (c) an evaporation zone located intermediate to the conversion zone and the hydrolysis zone, said evaporation zone allowing sublimation of silicate; (d) means for introducing a slag slurry feed into said conversion zone; and (e) means for introducing water into the hydrolysis zone.

In some embodiments, the reactor's one end and other end are the inlet and outlet of said reactor, respectively.

In other embodiments, the reactor is cylindrically-shaped having at least one inlet opening being at the reactor's one end and at least one outlet opening being at the reactor's other end.

The invention further provides in another of its aspects a multi-zone reactor assembly for silica conversion, said assembly comprising a reactor having at least three continuous zones comprising: (a) a conversion zone located in the reactor upper end for providing a slurry of smelter slag particulates and ammonium bifluoride; (b) an hydrolysis zone located in the reactor lower end for providing water to decompose the fluorides; (c) an evaporation zone located intermediate to the upper conversion zone and the lower hydrolysis zone, said evaporation zone allowing sublimation of silicate; (d) means for introducing a slag slurry feed into said conversion zone; and (e) means for introducing water into the hydrolysis zone.

In some embodiments, the reactor of the invention is a vertical gravitational reactor such as a shaft reactor. In other embodiments, the reactor is a horizontal reactor such as a rotating kiln, where each of the zones is positioned one following the other in a horizontal direction.

In some embodiments, the reactor further comprises means to extract silicon oxide from the lower end of said reactor.

In other embodiments, the reactor further comprises a flow regulator.

In still further embodiments, the reactor comprises a vapor outlet to permit evolution of gas from the upper or lower end of said reactor. The reactor may additionally comprise means to communicate said vapor to a scrubber.

In further embodiments, the reactor comprises a heating means to control the temperature of each of said multi-zones. In some embodiments, the heating means is in the form of multiple heaters being located on the outer surface of said cylindrical shaped reactor.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1 schematically illustrates an exemplary reactor 1 according to the invention, comprising of six sections;

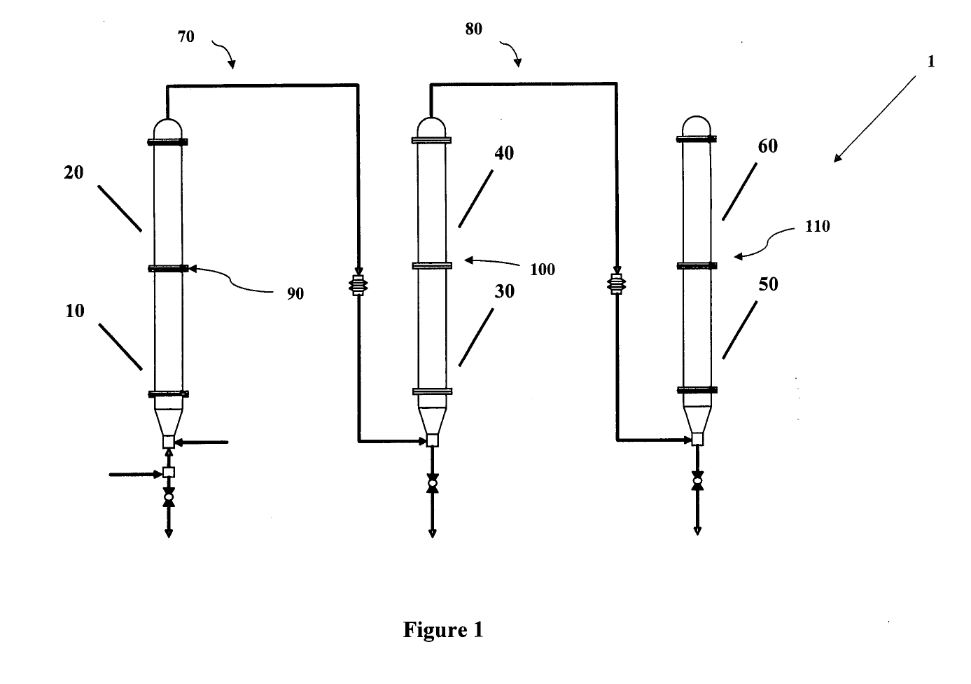

FIG. 2 schematically illustrates one section S1 of a reactor 1 according to the invention.

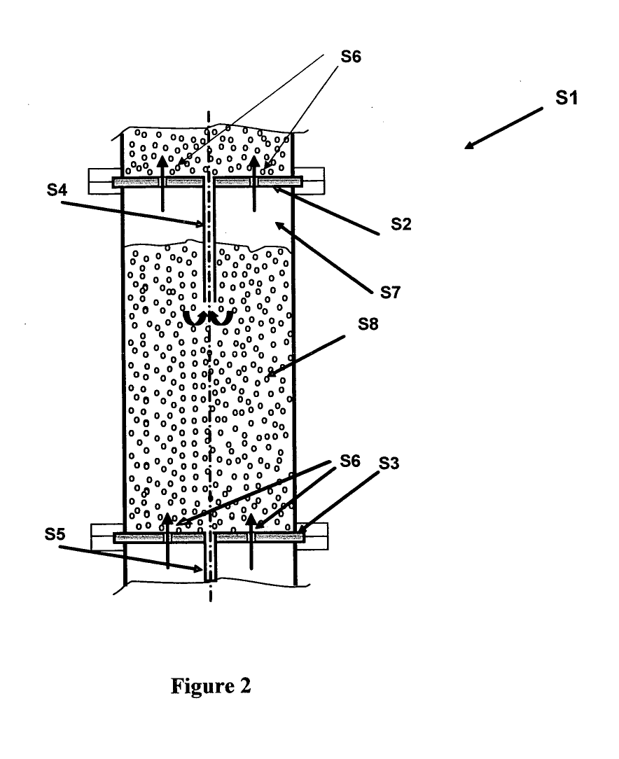

### DETAILED DESCRIPTION OF EMBODIMENTS

The process of the invention was employed on a variety of ores and raw materials comprising a great variety of metal values, such as copper, iron, gold, silver, zinc and non-metal elements such as elemental sulfur.

Without wishing to be bound by theory and for purposes of brevity and clarity, the following is a non-limiting description of the process of the invention. The examples concern extraction and isolation of metals value from raw material containing molybdenite.

### Example 1

### Extracting a Metal Value Such as Mo From a Combined Concentrate

1.1 A molybdenum concentrate containing 45-50% Mo, 3-5% Cu, traces of Re and impurities of Fe and SiO₂ was employed. The combined concentrate was fed into a 15-liter continuous bench scale mode of a reactor according to the invention, comprising at least 4 sections of internals.

1.2 The continuous leaching process in each run was performed for periods of 6 and 12 hours. Sampling was performed every hour and from each section to determine conversion ratio. Liquid phase samples were analyzed for Mo, Cu, Fe, Re, NO₃ and SO₄, and the solid phase for Mo, Cu, and free sulfur. Sampling and temperature control were installed in each section.

1.3 A slurry of solid combined concentrate in water was prepared in an agitated tank. Liquid to solid ratio in the slurry was in a range of 5-10 volumes of liquid to 1 portion in weight of combined concentrate (i.e., 5-10 Liter liquid/Kg dry solids).

1.4 The slurry was pumped by a dozing positive displacement pump to the reactor, while air enriched with oxygen (50%) was introduced into the reactor. A reactive oxidant solution (e.g., nitric acid, hypobromite, chlorates) was introduced to oxidate the sulfides, while its reduced species were recovered to the original oxidant in the slurry by oxygen in gas flow.

1.5 Reaction was processed while changes in the temperature in each section of the autoclave were monitored. A non-linear profile of temperature was achieved along the reactor's length, due to the exothermic conversion of sulfides to oxides and the adjusting to the required level by heating or by regulating the gas flow and mixture. The temperature profile in the reactor was determined to be in a range of 130-160° C. and up to 200-230° C.

1.6 Separating a solid cake was optionally followed by calcining thereof for obtaining technical grade metal oxide or by Ion-Exchange, for obtaining a pure metal salt. Slurry at outlet was filtrated and washed with water. Washed cake was calcined at 400-600° C., and the solution was next forwarded to the recovery of metals value.

1.7 The result sulfides conversion to molybdenum acid and oxides was more than 99% in average while the yield of Mo in filtered cake was detected to be in a range of 85% to 90%. Calcined cake was classified a technical grade with less than 0.01% S and less than 0.1% Cu.

### Example 2

### The Use of Nitric Acid as Oxidant and Oxygen

2.1 A molybdenum combined concentrate containing 30-35% Mo, 13-15% Cu, traces of Re and impurities of Fe an SiO₂ was employed. The combined concentrate was fed to a 15-liter continuous bench scale mode of a reactor of the invention, comprising six sections of internals.

2.2 Sampling was performed during tests, from each section of the reactor. Conversion values of molybdenite were also calculated, giving results for the number of the reactive mass transfer units in operation (i.e., reactive leaching contacts).

2.3 A slurry of solid combined concentrate in water was prepared in an agitated tank. Liquid to solid ratio in slurry was in a range of 5-10 volumes of liquid to 1 portion in weight of combined concentrate (i.e., 5-10 Liter liquid/Kg dry solids). Slurry pumping was adjusted to the retention time of solids in feed in the autoclave.

2.4 Nitric acid was continuously introduced by a dozing pump into the apparatus. Feed rate was changed during the set of tests, to maintain a controlled concentration of nitric acid in slurry.

2.5 For the nitric acid consumption, a number of tests were performed with acid concentrations ranging from 10 to 100 g/l. An in-situ recovery of nitric acid occurred during the reaction due to the contribution of the oxidative environment created by the oxygen in the gas flow. The longer the retention time was, the higher was the recycling of reduced nitric acid species to nitric acid. Use of a concentration of more than 60 g/l of nitric acid did not lead to a significant increase in the quality of the molybdenum acid obtained. The temperature was kept at the range 130-160° C., depending on the average retention time in the reactor.

2.6 Feed of oxygen was in a rate that comprises a stoichiometric excess of oxygen in a controlled level of 30%-50%.

2.7 Tests were conducted to determine the effect of the oxygen concentration in a throttled gas mixture. In some tests, pure oxygen was used. In some others, oxygen bearing mixtures were prepared by mixing pure oxygen and nitrogen in specific ratios from 50% to 90%. At a concentration above 90%, no significant increase in reaction rate was noted.

2.8 In order to determine the necessary retention time and its influence on molybdenum acid, tests were conducted by changing solid feed rate into the slurry at different nitric acid concentrations. Samples from sections 3, 4, 5 and 6 of the reactor were taken. Slurry pumping was adjusted. Mo conversion value was determined to be above 99.5%.

2.9 Under Mo conversion value of above, the reactive oxidant concentration were determined to be between 10-30 g/l.

2.10 Recycling efficiency of nitric acid was kept by detecting a minimum concentration of NO₂, in the gases at the outlet, to be under 20-50 ppm.

2.11 Condensing vapors from off-gasses enabled recycling to reaction. Recovery of more than 50% of the nitric acid was measured. Loss of nitric acid vapors were captured in a scrubber, where the rest of the nitric acid was locked in slurry which was subsequently further treated.

2.12 Retention time in terms of solids feed flux was in the range of 100-300 [kg solids/hr/m²].

Without wishing to be bound theory, it is suggested that the following occurs in the above process:

MoS₂ is oxidized and the nitric acid undergoes reduction to form nitrogen oxide: MoS₂+6HNO₃=H₂MoO₄+2H₂SO₄+6NO. The evolved NO interacts with oxygen forming nitrogen dioxide: NO+O₂=2NO₂=N₂O₄ and is then quickly absorbed by the water slurry, regenerating nitric acid which is recycled:

N₂O₄+H₂O=HNO₂+HNO₃

HNO₂+½O₂=HNO₃

Upon the simultaneous contact of the raw material i.e., the molybdenum slurry, the acid and the oxidizing gas, the oxidized metal separates leaving behind raw material which continuously interacts with the regenerated acid.

### Example 3

### The Use of Chlorate as an Oxidant and Chlorine Dioxide

3.1 A molybdenum combined concentrate containing 45-50% Mo, 3-5% Cu, traces of Re and impurities of Fe an SiO₂ was employed. The combined concentrate was fed to a 15-liter in volume of a continuous bench scale mode of the reactor of the invention, comprising at least 4 sections of internals.

3.2 Sampling was performed from sections 1-6 of the reactor. Conversion values of molybdenite were also calculated, giving results for the number of the reactive mass transfer units in operation (i.e., reactive leaching contacts).

3.3 A slurry of solid combined concentrate in water was prepared in an agitated tank. Liquid to solid ratio in the slurry was in the range of 5-10 volumes of liquid to 1 portion in weight of combined concentrate (i.e., 5-10 Liter liquid/Kg dry solids). Slurry pumping was adjusted to the retention time of solids in feed in the autoclave.

3.4 Sodium chlorate solution was continuously introduced by a dozing pump into the reactor. Feed rate was changed during set of tests, comprising a controlled level concentration of chlorate ion in slurry.

3.5 A number of tests were performed with chlorate ion (e.g., sodium chlorate in feed) concentrations ranging from 20 to 50 g chlorate ion per liter (g/l). An in-situ recovery of the chlorate ion took place during reaction due to the contribution of the oxidative environment created by chlorine oxide present in the gas flow. The longer the retention time was, the higher was the recovery of reduced chlorate in the reaction mixture. In the reactor, a concentration of more than 50 g/l of chlorate ion did not lead to a significant increase in the quality of the molybdic acid obtained.

Without wishing to be bound thereto, it is suggested that an in-situ make-up of the chlorate occurs during reaction due to the contribution of the oxidative environment created by the dissolving of chlorine dioxide from the gas flow to the slurry. The chemical reaction describing the oxidation of sulfides, occurring under acidic conditions, may be as follows:

2S⁻²+3ClO₃⁻¹+3H₂O=H₂MoO₄+2H₂SO₄+3Cl⁻¹.

Although ClO₂ is a peroxide, it remains in a monomolecular form. Thus, while dissolved in water, a disproportioning of ClO₂ occurs and a very reactive chlorate is evolved, providing an in-situ recovery of the chlorate in acidic pH, induced by the evolution of sulfuric acid and hydrochloric during chemical reaction: 6ClO₂+3H₂O=5HClO₃+HCl, where the Henry coefficient of ClO₂ is K_{H}⁰=0.8[bar*mole/Kg(so ln.)]. Thus, a stoichiometric relationship may be formulated as follows:

5MoS₂+18ClO₂+24H₂O=5H₂MoO₄+10H₂SO₄+18HCl,

where the total free energy gives ΔG₂₉₈_{⁰}ₖ⁰=−400Kcal/moleSulfide}.

3.6 The temperature was kept at the range of 90-130° C., depending on the average retention time in the reactor.

3.7 Feed of chlorine oxide was in a rate that maintains a stoichiometric excess of chlorine oxide at a controlled level up to 50%. An excess of more than 50% did not lead to a significant increase in the quality of the molybdic acid obtained.

3.8 Tests were conducted to determine the effect of the chlorine dioxide concentration in a throttled gas mixture. Chlorine dioxide bearing mixtures were prepared by mixing pure chlorine dioxide obtained from an electrochemical generator. Nitrogen is the non-reactive gas that was added to chlorine dioxide in specific ratios. In some tests, pure chlorine dioxide was used. In some other experiments, ClO₂ concentration in gas flow was between 40% and 60%. At a concentration of chlorine dioxide above 70% no significant increase in reaction rate was noted. Without wishing to be bound thereto, it is suggested that ClO₂ dissolves and reacts, while nitrogen supports hydrodynamic aspects of the reactor (apparatus) in use.

3.9 In order to determine the necessary retention time and its influence on molybdenum acid, tests were conducted while changing solids feed rate in the slurry at different chlorate ion concentrations. Samples were taken from sections 3, 4, 5 and 6 of the reactor. Slurry pumping was adjusted. Mo conversion value was determined to be above 98%.

3.10 Under the above Mo conversion value, the reactive oxidant (i.e., chlorate ion) concentration were determined to be between 15-20 g/l. The concentration was controlled by the adjustment of ClO₂ concentration in gas flow 40% and 60%, while keeping its molar excess at a controlled level up to 50%. The make-up concentration of the chlorate ion may be due to interference of chlorine dioxide. Results indicate that the retention time in terms of feed solids flux was in the range of 80-210 [kg solids/Hr/m²].

### Example 4

### Use of Hypobromite Ion as an Oxidant and Elementary Bromine

4.1 A molybdenum combined concentrate containing 30-35% Mo, 13-15% Cu, traces of Re and impurities of Fe and SiO₂ was employed. The combined concentrate was fed to a 15-liter in volume of a continuous bench scale mode of the reactor of the invention, comprising at least 4 sections of internals.

4.2 Sampling was performed during tests, from sections 1-6 of the reactor. Conversion values of molybdenite were also calculated, giving results for the number of the reactive mass transfer units in operation (i.e., reactive leaching contacts).

4.3 A slurry of solids combined concentrate in water was prepared in an agitated tank. Liquid to solid ratio in slurry was in a range of 5-10 volumes of liquid to 1 portion in weight of combined concentrate (i.e., 5-10 Liter liquid/Kg dry solids). Slurry pumping was adjusted to adjust the retention time of solids in feed in the autoclave.

4.4 A sodium hypobromite solution was continuously introduced by a dozing pump into the reactor. The feed rate was changed during set of tests, comprising a controlled concentration of hypobromite ion in slurry. The hypobromite ion was the reactive oxidant that reacted with the sulfides, oxidizing Mo into H₂MoO₄. During chemical reaction, hypobromite ion reacts while being converted into a reduced form.

4.5 It is suggested that an in-situ make-up of hypobromite occurs during reaction due to the contribution of the oxidative environment created by the dissolving of bromine from gas flow to slurry. Oxidation stage of sulfides in the acidic slurry is governed by the reaction: 1S⁻²+9BrO⁻¹+3H₂O=H₂MoO₄+2H₂SO₄+9Br⁻¹. As may be realized, when dissolved in water, bromine disproportionates while producing a reactive hypobromite ion which reacts with raw material. It follows the chemical scheme: Br₂+H₂O=HBrO+HBr; thereby, an in-situ recovery of hypobromite is achieved, leading to a stoichiometric formulation:

MoS₂+9Br₂+12H₂O=MoO₄⁻²+2SO₄⁻²+18Br⁻¹+24H⁺.

4.6 A number of tests were performed with hypobromite ion (e.g., Sodium hypobromite in feed) concentrations ranging from 20 to 70 gr hypobromite ion/liter. An in-situ make-up of hypobromite ion occurred during reaction due to the contribution of the oxidative environment created by bromine in the gas flow. In the reactor, a concentration of more than 50 g/l of sodium hypobromite ion did not lead to a significant increase in the quality of the molybdic acid obtained.

4.7 In order to stabilize the hypobromite ion in the slurry during reaction with sulfides, the pH was controlled to be between pH 8.5 to pH 9.5. This was obtained by adjusting the ratio between NaBrO to HBrO in the reaction mixture. Thus, besides the continuous feed of the sodium hypobromite solution, an added feed of 20% NaOH solution was required. This was obtained by keeping a ratio of 1.4-2.2 mole NaOH for every 1 mole of bromine in the gas flow.

4.8 The temperature was kept at the range of 90-130° C., depending on the average retention time in the reactor.

4.9 Feed of bromine gas was at a rate that permitted a stoichiometric excess of bromine at a controlled level up to 50%. An excess of more than 50% did not lead to a significant increase in the quality of the molybdic acid obtained.

4.10 Tests were conducted to determine the affect of the bromine concentration in a throttled gas mixture. Bromine bearing mixtures were prepared by mixing pure bromine with nitrogen as the non-reactive gas in mixture of the gas flow. Nitrogen was added to bromine in specific ratios. In some other experiments, bromine concentration in gas flow was between 20% and 40%. At a concentration of bromine above 40% no significant increase in reaction rate was noted. It is suggested that bromine dissolves and reacts, while nitrogen supports hydrodynamic aspects of the reactor.

4.11 In order to determine the necessary retention time and its influence on molybdenum acid, tests were conducted while changing solids feed rate in the slurry at different sodium hypobromite concentrations. Samples were taken from sections 3, 4, 5 and 6 of the reactor. Slurry pumping was adjusted. Mo conversion value was determined to be above 98%.

4.12 Under Mo conversion value of above, the reactive oxidant (i.e., hypobromite ion) concentration were determined to be between 30-60 g/liter. It was controlled by the adjustment of bromine concentration in gas flow 40% and 60%, while keeping its molar excess at a controlled level up to 50% and adjusting 20% soda caustic solution feed, within keeping pH in the range between 8.5 to 9.5. The make-up concentration of the hypobromite ion may be due to interference of bromine from the gas flow mixture.

4.13 Results indicate that the retention time in terms of feed solids flux was in the range of 60 and 125 [kgSolids/hr/m²].

### Example 5

### Recovery of Fe Sulfates and SiO₂ From Fayalite Matrices by Use of Sulfuric Acid

Slag material comprising fayalite matrices was contacted with concentrated sulfuric acid while rising the temperature to between 100 and 180° C., under oxidative conditions (sulfuric acid). The fayalite matrices reacted vigorously and disintegration of the slag occurred: 1[(FeO)₂.SiO₂]+2H₂SO₄→2FeSO₄+2H₂O+SiO₂. In the process, the mineral matrices collapsed, consequently the metal values which prior to disintegration were locked in the fayalite matrices, were released. As the reaction was carried out under oxidative conditions, the metal values were either retained in their original chemical form (e.g., sulfides, oxides etc.) or were transformed to a different electro valence form. The process may comprise additional processing to recovery further metal values.

### Example 6

### Recovery of Fe Sulfates and SiO₂ From Chalcopyrite Ore by Use of Sulfuric Acid

Chalcopyrite was contacted with concentrated sulfuric acid under oxidative chemical conditions and at a temperature in the range of 100-180° C. As known, upon exposure to air, chalcopyrite oxidizes to a variety of oxides, hydroxides and sulfates. Under the conditions of the process, the chalcopyrite mineral matrices reacted vigorously and its disintegration occurred following by the chemical scheme:

CuFeS₂+2H₂SO₄→FeSO₄+CuSO₄+2H₂O.

Consequently, metal values and non-metallic elements, which prior to the disintegration process were locked in the mineral matrices, were released. The process may comprise additional processing to recovery further metal and or non-metal values if present.

1. A process for isolating at least one metal value from a raw material, said process comprising:
(i) contacting said raw material in a vessel in the presence of a medium, wherein said medium comprising at least one oxidant, the vessel is configured to define a predetermined pressure and/or temperature condition, causing separation of a gaseous phase from said medium in contact with the material and providing a desired time of interaction between the separated gaseous phase and the material;
(ii) allowing said material to flow within the vessel to permit disintegration of said raw material and free said at least one metal value from the raw material, to enable isolation of said at least one metal value in a form selected from oxide, salt, complex and free metal.

2. The process according to claim 1, wherein said raw material is selected from a smelter slag, a combined concentrate, an ore, a solid waste stream, a tailing, and any combination of the aforesaid.

3. The process according to claim 2, wherein said smelter slag is selected from a copper slag, a nickel slag, and an iron slag.

4. The process according to claim 1, wherein said raw material is selected from fayalite, sphalerite, bornite, chalcocite, covellite, digenite, malachite, azurite and cuprite.

5. The process according to claim 1, wherein said metal value is selected from Cu, Fe, Si, Ca, Al, S, Zn, Pb, Au, Ag, U, Ni, Co, Re, V, W, Sn, Se, Te and Mo.

6. The process according to claim 5, wherein the isolated metal value is in a form selected from a metallic form, an elemental form, an oxidized form, a reduced form, and a sulfurized form.

7. The process according to claim 1, wherein said raw material is treated for size diminution by one or more of grinding, crushing, milling, attrition, and dissolution to convert said material into particles of smaller size.

8. The process according to claim 7, wherein said size diminution is carried out under dry conditions or in the presence of water or an aqueous solution.

9. The process according to claim 7, wherein said size diminution is carried out under acidic conditions.

10. The process according to claim 1, wherein the raw material is disintegrated in a liquid medium.

11. The process according to claim 10, wherein said medium comprises at least one oxidant.

12. The process according to claim 11, wherein said oxidant is an acid.

13. The process according to claim 12, wherein said acid is selected amongst elementary halogens, halogen oxides, halogenic oxy-acids, nitric acid, sulfuric acid, hydrogen bromide, hydrogen chloride and any mixture thereof.

14. The process according to claim 11, wherein the oxidant concentration is at most 50 g/l.

15. The process according to claim 14, wherein the oxidant concentration is between 10 and 30 g/l, or between 20 and 50 g/l or between 15 and 25 g/l.

16. The process according to claim 12, wherein said acid is nitric acid or a medium comprising thereof.

17. The process according to claim 16, wherein said medium being an aqueous nitric acid solution comprising nitric acid and oxygen in a mixture with nitrogen gas.

18. The process according to claim 17, wherein the nitric acid concentration is at least 10 g/l.

19. The process according to claim 18, wherein the nitric acid concentration is at most 60 g/l.

20. The process according to claim 18, wherein the nitric acid concentration is at most 60 g/l.

21. The process according to claim 20, wherein the nitric acid concentration is between 10 and 60 g/l, or between 10 and 30 g/l, or between 15 and 25 g/l, or between 20 and 25 g/l.

22. The process according to claim 12, wherein said acid is hypobromite or a medium comprising thereof.

23. The process according to claim 22, wherein said hypobromite is sodium hypobromite.

24. The process according to claim 22, wherein said hypobromite medium comprises a hypobromite salt and bromine, in a mixture with nitrogen gas.

25. The process according to claim 24, wherein the bromine concentration in the gas is between 20 and 60%, or between 20 and 40%.

26. The process according to claim 12, wherein said acid is a chlorate salt or a medium comprising thereof.

27. The process according to claim 26, wherein said chlorate salt is sodium chlorate.

28. The process according to claim 26, wherein the medium comprises a chlorate salt and chlorine dioxide.

29. The process according to claim 26, wherein the chlorate ion concentration is between 15 and 20 g/l or between 20 and 50 g/l.

30. The process according to claim 28, wherein the chlorine dioxide concentration in the gas flow is between 40 and 60%.

31. The process according to claim 24, wherein the hypobromite ion concentration is at least 20 g/l or at least 30 g/l.

32. The process according to claim 31, wherein said hypobromite ion concentration is at most 60 g/l or at most 70 g/l.

33. The process according to claim 1, wherein said medium comprises oxygen or a gaseous mixture comprising oxygen.

34. The process according to claim 33, the oxygen being in a concentration of between about 30 and 100%.

35. The process according to claim 1, being carried out under a temperature between 90 and 130° C., or between 100 and 160° C. or between 130 and 160° C.

36. The process according to claim 1, being a continuous process.

37. The process according to claim 1, wherein upon contacting said raw material with the oxidant, froth is obtained, said froth having a high surface area permitting continuous contact with the oxidant.

38. The process according to claim 1, comprising:
(i) contacting said raw material in a vessel with an acidic medium, causing separation of a gaseous phase from said medium in contact with the raw material to convert at least an amount of the metal values contained in said raw material into a corresponding medium-soluble form;
(ii) allowing said raw material to continuously flow within the vessel to permit disintegration of a further amount of the raw material, until the metal values are leached out from the raw material into the medium to obtain a leach liquor;
(iii) separating vapors and gases from the medium for acid condensation and recirculation;
(iv) separating the leach liquor, and
(v) separating the insoluble material as a solid cake, optionally drying and further optionally calcining the cake to obtain meal oxides of a desired grade.

39. The process according to claim 38, further comprising dissolving the cake and separating therefrom metal values.

40. The process according to claim 38, further comprising oxidization of the leached metal values in the acidic medium, in the presence of air/oxygen and allowing the slurry to float by the introduction of a gaseous flow into the vessel.

41. The process according to claim 38, further comprising separation of the medium-soluble ions and selective separation of the different metal values.

42. The process according to claim 1, wherein the vessel for carrying out the process is an autoclave.

43. The process according to claim 42, wherein the reactor is a vertical or horizontal (pipe) autoclave.

44. The process according to claim 43, wherein said reactor is the form of a vertical column.

45. The process according to claim 1, wherein the vessel is a reactor comprising at least two interconnected reaction chambers, each two locally adjacent reaction chambers being connected to one another, each chamber having a partition in the form of a material passage unit being an outlet opening for one chamber and the inlet opening for an adjacent chamber, said material passage unit being configured to define within a chamber a predetermined pressure condition causing separation of a gaseous phase from said material and providing a desired time of interaction between the separated gaseous phase and remaining material, after which the material flows through the outlet of said chamber into the adjacent chamber and towards the passage unit defining a partition between said adjacent chamber and a subsequent chamber, the time of interaction between said gas phase and the material in each of said at least two chambers defining the reactor throughput.

46. The process according to claim 45, wherein the material being in contact with the gaseous phase is in the form of a froth of a high surface area.

47. The process according to claim 45, wherein said material passage unit is in the form of a perforation pattern.

48. A reactor comprising at least two interconnected reaction chambers, each two locally adjacent reaction chambers being connected to one another, each chamber having a partition in the form of a material passage unit being an outlet opening for one chamber and the inlet opening for an adjacent chamber, said material passage unit being in the form of a perforation pattern, optionally having a concave pattern, configured to define within a chamber a predetermined pressure condition causing separation of a gaseous phase from said material and providing a desired time of interaction between the separated gaseous phase and remaining material, after which the material flows through the outlet of said chamber into the adjacent chamber and towards the passage unit defining a partition between said adjacent chamber and a subsequent chamber, the time of interaction between said gas phase and the material in each of said at least two chambers defining the reactor throughput.
